(19) United States
(12) Patent Application Publication
(10) Pub. No.: US 2014/0192637 A1
(43) Pub. Date: Jul. 10, 2014

(54) METHOD AND APPARATUS FOR IMPLEMENTING PROXIMITY SERVICES IN A WIRELESS COMMUNICATION SYSTEM

(71) Applicant: INNOVATIVE SONIC CORPORATION, Taipei City (TW)

(72) Inventor: Meng-Hui Ou, Taipei City (TW)

(73) Assignee: INNOVATIVE SONIC CORPORATION, Taipei City (TW)

(21) Appl. No.: 14/148,064

(22) Filed: Jan. 6, 2014

Related U.S. Application Data
(60) Provisional application No. 61/749,540, filed on Jan. 7, 2013.

(51) Int. Cl. H04W 40/20; H04W 24/04

(52) U.S. Cl. CPC H04W 40/20; H04W 24/04
USPC 370/228; 370/328

(57) ABSTRACT

A method and apparatus for implementing ProSe (Proximity Services) are disclosed. The method includes using ProSe communication with direct mode data path. The method also includes sending a request to an eNB (evolved Node B) to establish ProSe communication with locally-routed data path.

### CROSS-REFERENCE TO RELATED APPLICATIONS

The present Application claims the benefit of U.S. Provisional Patent Application Ser. No. 61/749,540 filed on Jan. 7, 2013, the entire disclosure of which is incorporated herein by reference.

### FIELD

This disclosure generally relates to wireless communication networks, and more particularly, to a method and apparatus for implementing ProSe (Proximity Services) in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus for implementing ProSe (Proximity Services) are disclosed. The method includes using ProSe communication with direct mode data path. The method also includes sending a request to an eNB (evolved Node B) to establish ProSe communication with locally-routed data path.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram of a default data path setup in an EPS (Evolved Packet System) for communication between two UEs (User Equipment) according to one exemplary embodiment.

FIG. 6 is a diagram of a direct mode data path in an EPS for communication between two UEs according to one exemplary embodiment.

FIG. 7 is a diagram of a locally-routed data path in an EPS for communication between two UEs when UEs are served by the same eNB (evolved Node B) according to one exemplary embodiment.

FIG. 8 illustrates an exemplary control path for network supported ProSe communication for UEs served by the same eNB according to one exemplary embodiment.

FIG. 9 is a flow chart according to one exemplary embodiment.

FIG. 10 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, the exemplary wireless communication systems devices described below may be designed to support one or more standards such as the standard offered by a consortium named “3rd Generation Partnership Project” referred to herein as 3GPP, including Document Nos. TR 22.803-110, “Feasibility Study for Proximity Services (ProSe)”; TS 36.331 V11.1.0, “E-UTRA RRC protocol specification (Release 11)”; TS 36.304 v11.1.0, “User Equipment (UE) procedures in idle mode (Release 11)”. The standards and documents listed above are hereby expressly incorporated herein.

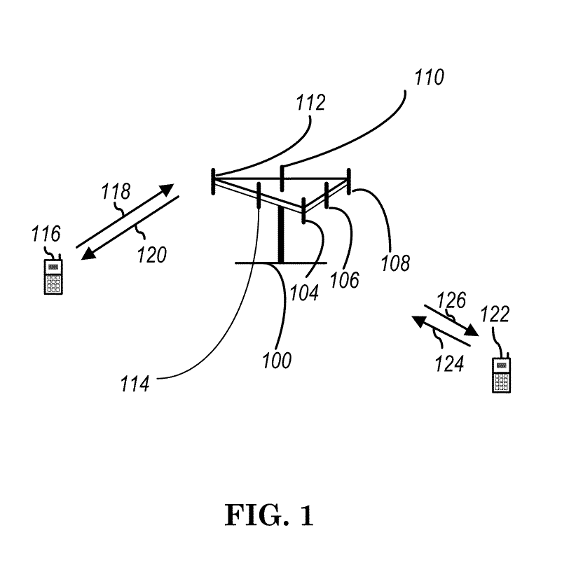

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

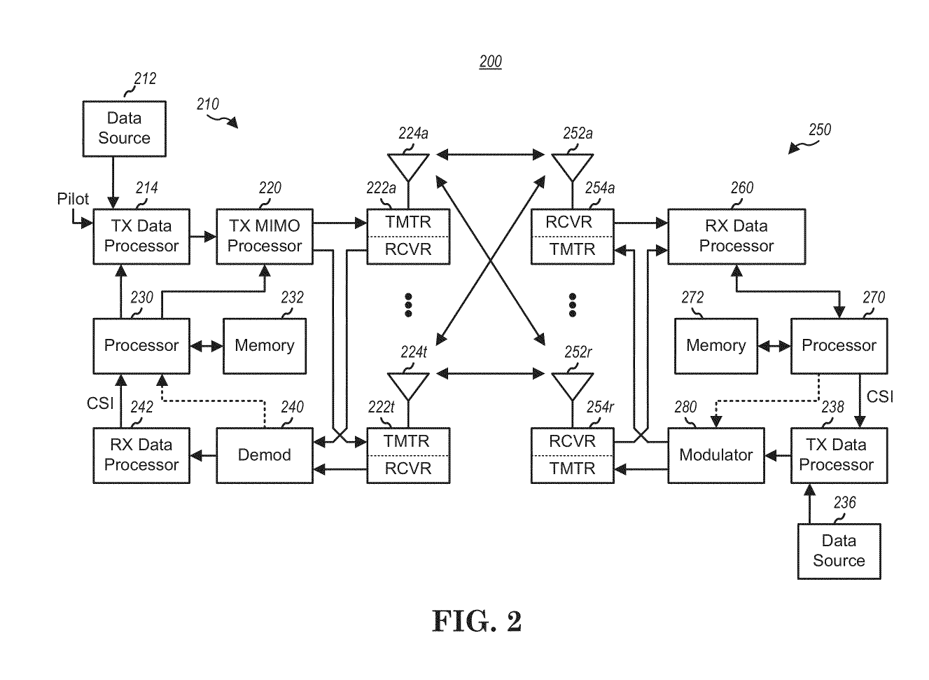

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

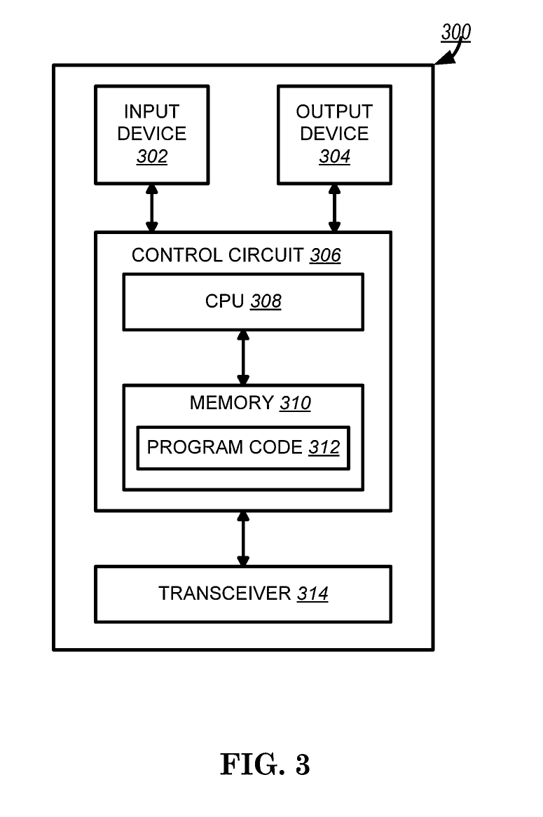

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

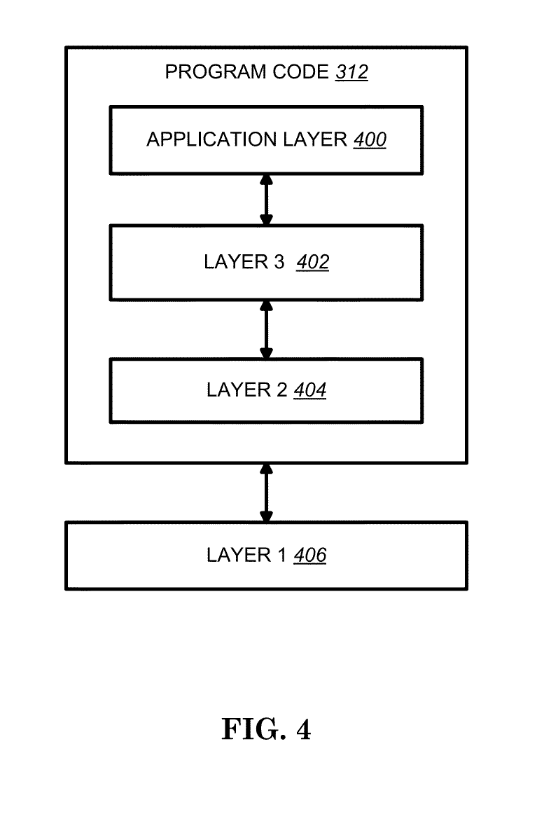

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

Proximity services (ProSe) have been studied in 3GPP SA in Release 12. The feasibility study for proximity services is captured in 3GPP TR 22.803-110. Section 1 of 3GPP TR 22.803-110 specifies the objective of the study as follows:

The objective is to study use cases and identify potential requirements for an operator network controlled discovery and communications between devices that are in proximity, under continuous network control, and are under a 3GPP network coverage, for:

1. Commercial/social use

2. Network offloading

3. Public Safety

4. Integration of current infrastructure services, to assure the consistency of the user experience including reachability and mobility aspects

Additionally, the study item will study use cases and identify potential requirements for

5. Public Safety, in case of absence of EUTRAN coverage (subject to regional regulation and operator policy, and limited to specific public-safety designated frequency bands and terminals)

Use cases and service requirements will be studied including network operator control, authentication, authorization, accounting and regulatory aspects. The study does not apply to GERAN or UTRAN.

Section 3 of 3GPP TR 22.803-110 specifies the definitions of certain terms used for the study of proximity services as follows:

### 3.1 Definitions

ProSe Communication: a communication between two UEs in proximity by means of a communication path established between the UEs. The communication path could for example be established directly between the UEs or routed via local eNB(s).

ProSe Group Communication: a one-to-many ProSe Communication, between two or more UEs in proximity, by means of a common communication path established between the UEs.

ProSe Broadcast Communication: a one-to-all ProSe Communication, between all authorized UEs in proximity, by means of a common communication path established between the UEs.

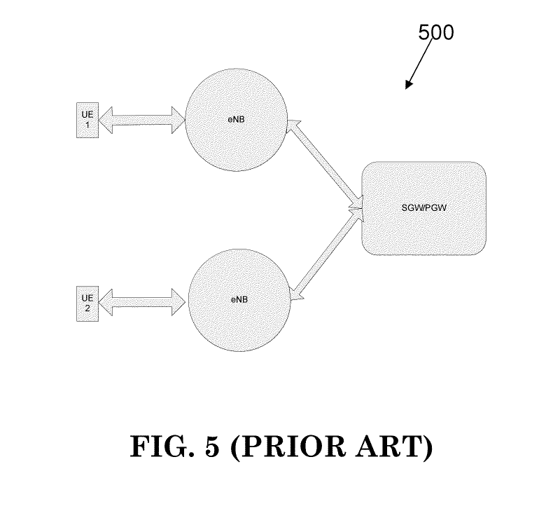

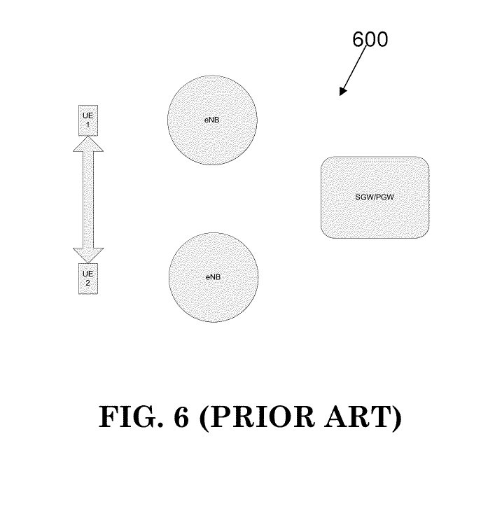

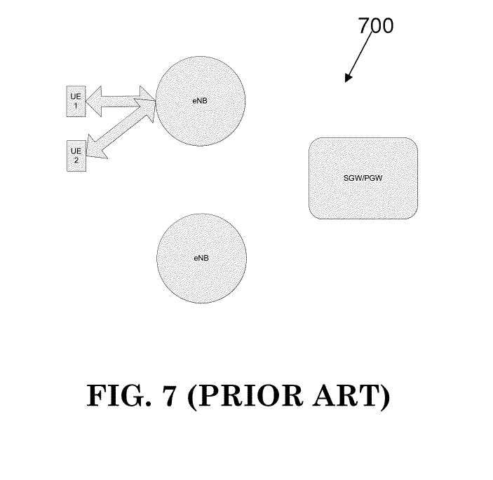

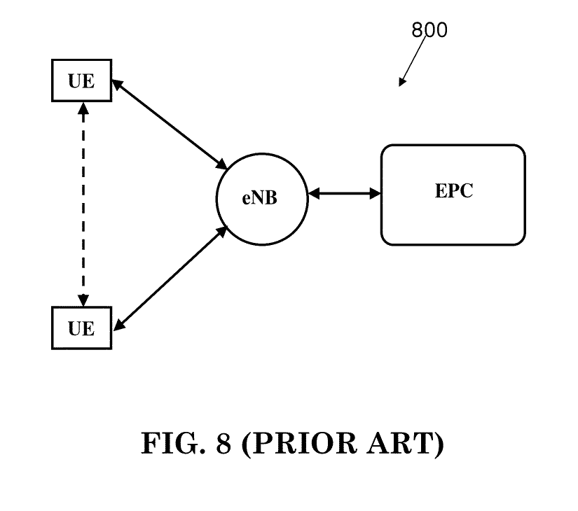

Section 4 of 3GPP TR 22.803-110 discusses the differences between the default data path (or called infrastructure path) scenario and the ProSe communication scenario. For the default data path scenario, the data path (user plane) goes through the operator network. The typical data path for this type of communication is shown in FIG. 5, where eNB(s) and/or GW(s) are involved. For ProSe communication scenario, if UEs are in proximity of each other, they may be able to use a local or direct path. FIG. 6 and FIG. 7 show two examples of the data path for ProSe communication, and FIG. 8 shows an example of control path for ProSe communication.

Section 5 of 3GPP TR 22.803-110 specifies the cases and scenarios in which ProSe may be used as follows:

### 5.2.7 ProSe Group

5.2.7.1 Description

This use case describes the scenario where a user wants to communicate the same information concurrently to two or more other users using ProSe Group Communications. The UEs of all users in the scenario belong to a common communications group.

5.2.7.2 Pre-Conditions

An operator offers a service, which makes use of the ProSe feature.

Officer A, Officer B, and Officer C use ProSe-enabled public safety UEs.

Officer A, B, and C's UEs are configured to belong to communications group X.

Officer C has disabled ProSe Discovery on his/her UE.

Officer A, Officer B, and Officer C are subscribed to a Public Safety service that allows them to use ProSe.

Officer A's UE has discovered Officer B's UE via ProSe Discovery.

Officer A's UE has not discovered Officer C's UE via ProSe.

5.2.7.3 Service Flows Officer A's UE transmits data using ProSe Group Communications to Officer B and Officer C's UEs concurrently.

5.2.7.4 Post-Conditions

None.

5.2.7.5 Potential Requirements

[PR.61] A Public Safety UE shall be capable of transmitting data to a group of Public Safety UEs using ProSe Group Communications with a single transmission, assuming they are within transmission range, authenticated and authorized.

[PR.118] Authentication shall allow for security-enablement of large groups, regardless of whether group members have discovered each other.

[PR.62] A Public Safety UE shall be capable of transmitting data to a group of Public Safety UEs directly using ProSe Group Communications.

[PR.63] A Public Safety UE shall be capable of receiving a ProSe Group Communications transmission, of which it is a group member, regardless of whether or not it has been discovered by the transmitting UE.

Group management is outside the scope of ProSe.

When two UEs are using direct mode ProSe communication (as illustrated in FIG. 6), the UEs may move apart from each other since they are mobile. If the distance between the UEs is too long to maintain the direct peer-to-peer communication, the data session would be closed or switched to infrastructure path (as illustrated in FIG. 5). According to 3GPP TR 22.803-110, the system should have the capability of switching (or moving) a user traffic session from an E-UTRA (Evolved Universal Terrestrial Radio Access) ProSe communication path to an infrastructure path. At a minimum, such switching shall support the case when the E-UTRA ProSe Communication path is no longer feasible.

However, since an objective of ProSe communication is network offloading, switching a data session from ProSe communication path to infrastructure path would increase the loading of the core network, which is less desirable. The ProSe communication should be used as much as possible from the network offloading point of view.

In general, a concept of the present invention is that while direct mode ProSe communication could only be applied to the UEs that could reach each other, locally-routed ProSe communication could be used to communicate the UEs beyond the range of direct peer-to-peer communication. More specifically, when a UE is using direct mode ProSe communication, if the direct link is no longer feasible or some radio problem is detected, the UE could and should try to use locally-routed ProSe communication instead.

In one embodiment, when a UE is using a direct link and the direct link is no longer feasible or some radio problem is detected, the UE could request its eNB to establish a locally-routed ProSe communication. The UE could inform the eNB of the peer UE (e.g., providing some kind of identity of the peer UE). The UE could also inform the eNB of the ongoing data session.

In an alternative embodiment, an eNB could try to establish a locally-routed ProSe communication for a UE upon requested from the UE. If the eNB could establish the locally-routed ProSe communication for the UE, the eNB could switch the data path from direct link to locally-routed path. Furthermore, if the eNB cannot find the peer UE or cannot establish a locally-routed ProSe communication, the eNB would then try to establish communication via infrastructure path instead.

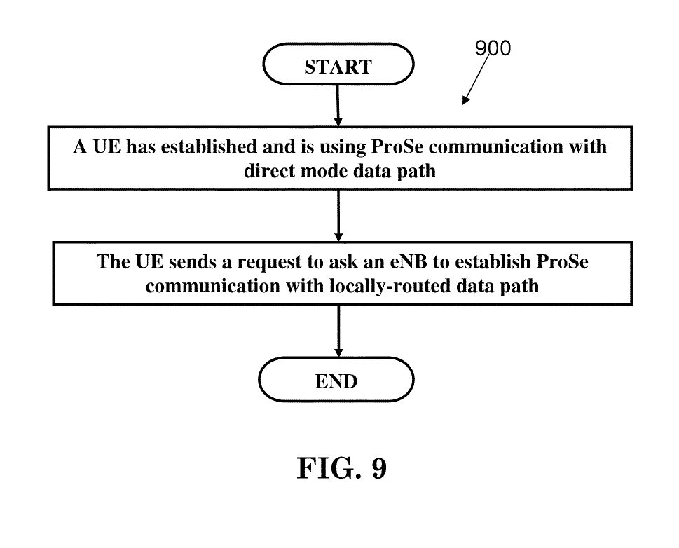

FIG. 9 is diagram 900 in accordance with one exemplary embodiment. In step 905, a UE has established and is using ProSe communication with direct mode data path. In step 910, the UE could send a request to ask an eNB to establish ProSe communication with locally-routed data path. In one embodiment, the UE could send a request to ask the eNB to switch the data path of ProSe communication from direct mode data path to locally-routed data path. The request could be sent when the direct mode data path is considered not reliable or no longer feasible.

In one embodiment, the direct mode data path would be deemed not reliable or no longer feasible when a radio problem or a radio link failure is detected on the direct mode data path. In another embodiment, the UE could be ProSe-enabled, could be authorized and/or authenticated for using the proximity services, and/or could be in connected mode.

In one embodiment, the ProSe communication with locally-routed data path is for a same data session as the ProSe communication with direct mode data path. In another embodiment the ProSe communication with locally-routed data path is the ProSe communication via one or more eNBs. In addition, the ProSe communication with direct mode data path is the ProSe communication via the direct link between the UE and its peer UE.

In one embodiment, the request to the eNB could include an UE identity (which could be used for proximity services) of a peer UE of the ProSe communication, an identity of a data session involved in the ProSe communication, and/or an identity of a service (or application) involved in the ProSe communication. In another embodiment, the request to the eNB could be sent via a RRC (Radio Resource Control) message.

Referring back to FIGS. 3 and 4, in one embodiment, the device 300 could include a program code 312 stored in memory 310 to implement ProSe in a UE. In one embodiment, the CPU 308 could execute the program code 312 (i) to establish and use ProSe communication with direct mode data path, and (ii) to send a request to ask an eNB to establish ProSe communication with locally-routed data path. In one embodiment, the CPU 308 could execute the program code 312 to send a request to ask the eNB to switch the data path of ProSe communication from direct mode data path to locally-routed data path. The request could be sent when the direct mode data path is considered not reliable or no longer feasible. In addition, the CPU 308 could execute the program code 312 to perform all of the above-described actions and steps or others described herein.

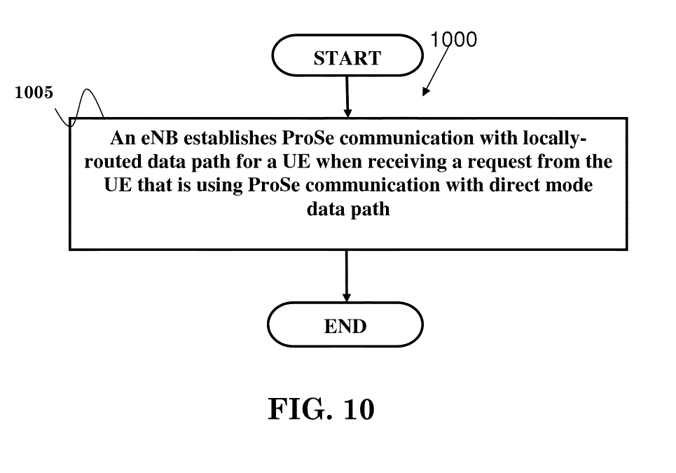

FIG. 10 is a flow chart 1000 in accordance with one exemplary embodiment. In step 1005, an eNB establishes ProSe communication with locally-routed data path for a UE when receiving a request from the UE that is using ProSe communication with direct mode data path. In one embodiment, the eNB switches the data path of ProSe communication from direct mode data path to locally-routed data path. The UE could request such switching when the direct mode data path is deemed not reliable or no longer feasible.

In one embodiment, the direct mode data path would be deemed not reliable or no longer feasible when a radio problem or a radio link failure is detected on the direct mode data path. In another embodiment, the UE could be ProSe-enabled, could be authorized and/or authenticated for using the proximity services, and/or could be in connected mode.

In one embodiment, the ProSe communication with locally-routed data path is for a same data session as the ProSe communication with direct mode data path. In another embodiment, the ProSe communication with locally-routed data path is the ProSe communication via one or more eNBs. In addition, the ProSe communication with direct mode data path is the ProSe communication via the direct link between the UE and its peer UE.

In one embodiment, the request to the eNB could include an UE identity (which could be used for proximity services) of a peer UE of the ProSe communication, an identity of a data session involved in the ProSe communication, and/or an identity of a service (or application) involved in the ProSe communication. In another embodiment, the request to the eNB could be sent via a RRC (Radio Resource Control) message.

Referring back to FIGS. 3 and 4, the device 300 could include a program code 312 stored in memory 310 to implement ProSe. In one embodiment, the CPU 308 could execute the program code 312 to establish ProSe communication with locally-routed data path for a UE when receiving a request from the UE that is using ProSe communication with direct mode data path. In one embodiment, the CPU 308 could execute the program code 312 to switch the data path of ProSe communication from direct mode data path to locally-routed data path. In addition, the CPU 308 could execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for implementing ProSe (Proximity Services) in a UE (User Equipment), comprising:
using ProSe communication with direct mode data path; and
sending a request to an eNB (evolved Node B) to establish ProSe communication with locally-routed data path.

2. The method of claim 1, wherein the UE sends the request to switch a data path of ProSe communication from direct mode data path to locally-routed data path.

3. The method of claim 1, wherein the UE sends the request when the direct mode data path is considered not reliable or no longer feasible.

4. A method for implementing ProSe (Proximity Services) in an eNB (evolved Node B), comprising:
establishing ProSe communication with locally-routed data path for a UE when receiving a request from the UE that is using ProSe communication with direct mode data path.

5. The method of claim 4, wherein the eNB switches a data path of ProSe communication from direct mode data path to locally routed data path.

6. The method of claim 1, wherein the ProSe communication with locally-routed data path is the ProSe communication via one or more eNBs.

7. The method of claim 1, wherein the ProSe communication with direct mode data path is the ProSe communication via the direct link between the UE and its peer UE.

8. The method of claim 1, wherein the request to the eNB includes an identity of a peer UE of the ProSe communication, an identity of a data session involved in the ProSe communication, and/or an identity of a service (or application) involved in the ProSe communication.

9. The method of claim 1, wherein the UE is ProSe-enabled, is authorized and/or authenticated for using the proximity services, and/or is in connected mode.

10. The method of claim 3, wherein the direct mode data path is considered not reliable or no longer feasible when a radio problem or a radio link failure is detected on the direct mode data path.

11. A communication device to implement ProSe (Proximity Services) in a UE (User Equipment), the communication device comprising:
a control circuit;
a processor installed in the control circuit;
a memory installed in the control circuit and operatively coupled to the processor;
wherein the processor is configured to execute a program code stored in the memory to:
use ProSe communication with direct mode data path; and
send a request to an eNB (evolved Node B) to establish ProSe communication with locally-routed data path.

12. The communication device of claim 11, wherein the UE sends the request to switch a data path of ProSe communication from direct mode data path to locally-routed data path.

13. The communication device of claim 11, wherein the UE sends the request when the direct mode data path is considered not reliable or no longer feasible.

14. The communication device of claim 11, wherein the ProSe communication with direct mode data path is the ProSe communication via the direct link between the UE and its peer UE.

15. The communication device of claim 11, wherein the ProSe communication with locally-routed data path is the ProSe communication via one or more eNBs.

16. The communication device of claim 11, wherein the request to the eNB includes an identity of a peer UE of the ProSe communication, an identity of a data session involved in the ProSe communication, and/or an identity of a service (or application) involved in the ProSe communication.

17. The communication device of claim 11, wherein the UE is ProSe-enabled, is authorized and/or authenticated for using the proximity services, and/or is in connected mode.

18. The communication device of claim 11, wherein the direct mode data path is considered not reliable or no longer feasible when a radio problem or a radio link failure is detected on the direct mode data path.
